(19) United States
(12) Patent Application Publication
(10) Pub. No.: US 2026/0220918 A1
(43) Pub. Date: Jul. 30, 2026

(54) METHOD, APPARATUS, DEVICE, AND STORAGE MEDIUM FOR VIDEO CONTENT-BASED PROCESSING

(71) Applicant: Beijing Youzhuju Network Technology Co., Ltd., Beijing (CN)

(72) Inventors: Yongzhi Li, Beijing (CN); Ming Zhou, Beijing (CN); Zehuan Yuan, Beijing (CN)

(21) Appl. No.: 19/147,664

(22) PCT Filed: Apr. 2, 2024
(86) PCT No.: PCT/CN2024/085668

§ 371 Date: Jul. 11, 2025

(30) Foreign Application Priority Data
Apr. 24, 2023 (CN) 202310449743.6

(51) Int. Cl. G06V 10/77; G06F 16/334; G06Q 30/0601

(52) U.S. Cl. CPC G06V 10/7715; G06F 16/334; G06Q 30/0641

(57) ABSTRACT

Embodiments of the present disclosure relate to a method, an apparatus, a device, and a storage medium for video content-based processing. The method includes determining a plurality of video frames associated with a target object in a target video; determining a target feature representation of the target object based on a plurality of visual features of the target object in the plurality of video frames; and determining at least one search result associated with the target object based on the target feature representation. Based on the above way, embodiments of the present disclosure may achieve more accurate content search by the visual features of the same object in the plurality of video frames.

This application claims priority to Chinese Patent Application No. 202310449743.6, filed on Apr. 24, 2023, and entitled “METHOD, APPARATUS, DEVICE, AND STORAGE MEDIUM FOR VIDEO CONTENT-BASED PROCESSING”, which is incorporated herein by reference in its entirety.

### FIELD

Example embodiments of the present disclosure relate generally to the field of computer, and in particular, to a method, an apparatus, a device, and a computer-readable storage medium for video content-based processing.

### BACKGROUND

With the development of computer technology, the Internet has been able to provide people with a variety of content. People may obtain content of interest more efficiently through search technology. For example, people may obtain matching search results by entering keywords, or may obtain other visually similar pictures by uploading pictures. Therefore, how to provide people with more accurate search results is currently a focus of attention.

### SUMMARY

In a first aspect of the present disclosure, a method for video content-based processing is provided. The method includes determining, in a target video, a plurality of video frames associated with a target object; determining a target feature representation of the target object based on a plurality of visual features of the target object in the plurality of video frames; and determining at least one search result associated with the target object based on the target feature representation.

In a second aspect of the present disclosure, an apparatus for video content-based processing is provided. The apparatus includes: a detecting module configured to determine, in a target video, a plurality of video frames associated with a target object; a determining module configured to determine a target feature representation of the target object based on a plurality of visual features of the target object in the plurality of video frames; and a search module configured to determine at least one search result associated with the target object based on the target feature representation.

In a third aspect of the present disclosure, an electronic device is provided. The device includes at least one processing unit; and at least one memory coupled to the at least one processing unit and storing instructions executable by the at least one processing unit, the instructions, when executed by the at least one processing unit, causing the device to perform the method according to the first aspect.

In a fourth aspect of the present disclosure, a computer-readable storage medium is provided. The computer-readable storage medium has a computer program stored thereon, the computer program being executable by a processor to implement the method according to the first aspect.

In a fifth aspect of the present disclosure, a computer program product is provided, including computer-executable instructions, where the computer-executable instructions, when executed by a processor, implement the method according to the first aspect.

It should be understood that the content described in this section is not intended to limit the key features or important features of the embodiments of the present disclosure, nor is it intended to limit the scope of the present disclosure. Other features of the present disclosure will become readily apparent from the following description.

### BRIEF DESCRIPTION OF THE DRAWINGS

The above and other features, advantages, and aspects of the embodiments of the present disclosure will become more apparent when taken in conjunction with the drawings and with reference to the following detailed description. In the drawings, the same or similar reference numerals refer to the same or similar elements, where:

FIG. 1 shows a schematic diagram of an example environment in which embodiments of the present disclosure may be implemented;

FIG. 2 shows a flowchart of an example process of video content-based processing according to some embodiments of the present disclosure;

FIG. 3A and FIG. 3B show schematic diagrams of video content-based processing according to some embodiments of the present disclosure;

FIG. 4 shows a schematic structural block diagram of an apparatus for video content-based processing according to some embodiments of the present disclosure; and

FIG. 5 shows a block diagram of an electronic device capable of implementing multiple embodiments of the present disclosure.

### DETAILED DESCRIPTION

Embodiments of the present disclosure will be described in more detail below with reference to the drawings. Although some embodiments of the present disclosure are shown in the drawings, it should be understood that the present disclosure may be implemented in various forms, and should not be construed as being limited to the embodiments set forth herein. Rather, these embodiments are provided for a more thorough and complete understanding of the present disclosure. It should be understood that the drawings and embodiments of the present disclosure are only for illustrative purposes, and are not intended to limit the scope of protection of the present disclosure.

It should be noted that the title of any section/sub-section provided herein is not limiting. Various embodiments are described throughout this document, and any type of embodiment may be included under any section/sub-section. In addition, the embodiments described in any section/sub-section may be combined in any way with any other embodiments described in the same section/sub-section and/or different section/sub-section.

In the description of the embodiments of the present disclosure, the term “include/comprise” and similar terms should be understood as open-ended inclusions, that is, “include/comprise but not limited to”. The term “based on” should be understood as “based at least in part on”. The term “one embodiment” or “the embodiment” should be understood as “at least one embodiment”. The term “some embodiments” should be understood as “at least some embodiments”. Other explicit and implicit definitions may also be included below. The terms “first”, “second”, etc. may refer to different or the same objects. Other explicit and implicit definitions may also be included below.

The embodiments of the present disclosure may involve user data, acquisition and/or use of data, and the like. These aspects follow corresponding laws, regulations and relevant regulations. In the embodiments of the present disclosure, the collection, acquisition, processing, forwarding, use, etc. of all data are carried out on the premise that the user is aware and confirms. Accordingly, when implementing the embodiments of the present disclosure, the user should be informed of the type, scope of use, usage scenario, etc. of the data or information that may be involved and obtain the user's authorization through appropriate means in accordance with relevant laws and regulations. The specific way of notification and/or authorization may vary according to actual situations and application scenarios, and the scope of the present disclosure is not limited in this respect.

If the solutions in this specification and the embodiments involve personal information processing, they will be processed on the premise of having a legal basis (for example, obtaining the consent of the personal information subject, or being necessary to perform a contract, etc.), and will only be processed within the specified or agreed scope. The user refuses to process personal information other than the necessary information required for basic functions, which will not affect the user's use of basic functions.

As briefly mentioned above, the Internet may provide users with a vast amount of content. People expect to be able to obtain desired content more efficiently and accurately. Some traditional search technologies may provide users with text-based or image-based search. However, for video content, such traditional search solutions may not provide high-quality search.

Embodiments of the present disclosure propose a search solution based on video content. According to the solution, a plurality of video frames associated with a target object in a target video are determined; a target feature representation of the target object is determined based on a plurality of visual features of the target object in the plurality of video frames; and at least one search result associated with the target object is determined based on the target feature representation.

In this way, embodiments of the present disclosure may perform more accurate search by detecting the target object in the video and aggregating the visual features in the plurality of video frames. Thus, the accuracy of the provided search results may be improved.

Various example implementations of the solution will further be described in detail below with reference to the drawings.

### Example Environment

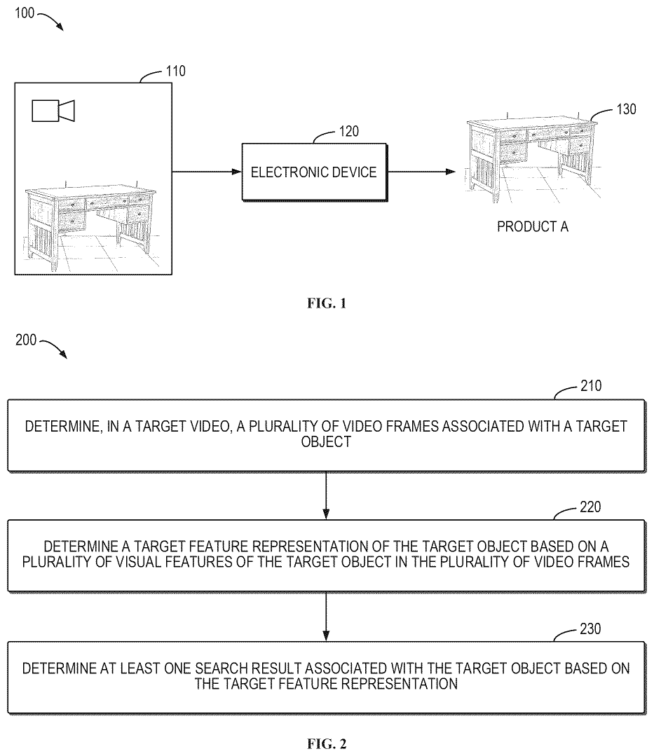

FIG. 1 shows a schematic diagram of an example environment 100 in which embodiments of the present disclosure may be implemented. As shown in FIG. 1, the environment 100 may include an electronic device 120. The automatic device 120 may include any suitable electronic device, examples of which may include, but are not limited to: a mobile device, a tablet computer, a laptop computer, a desktop computer, a cloud server, an edge computing device, and the like.

As shown in FIG. 1, the electronic device 120 may acquire a target video 110, and further provide a search result 130 related to the target video 110.

As an example, the target video 110 may include, for example, a video file uploaded by a user. For example, the user may upload a video file for searching through a search entry. Additionally or alternatively, the target video 110 may also include, for example, a published video work. Additionally or alternatively, the target video 110 may also include, for example, live video content, e.g., a live video stream.

Additionally, the search result 130 may include, for example, a result matching an object included in the target video 110. The search result 130 may include, for example, content of a suitable type. Taking FIG. 1 as an example, the search result 130 may include, for example, a product matching the object in the video 110.

As other examples, the search result 130 may also include, for example, other visual content, such as a picture or a video.

It should be understood that the structure and function of the environment 100 are described for illustrative purposes only, without implying any limitation to the scope of the present disclosure.

### Example Process

FIG. 2 shows a flowchart of an example process 200 of video content-based processing according to some embodiments of the present disclosure. The process 200 may be implemented at the electronic device 120. The process 200 is described below with reference to FIG. 1.

As shown in FIG. 2, at block 210, the electronic device 120 determines a plurality of video frames associated with a target object in a target video.

As introduced above, the electronic device 120 may acquire the target video by appropriate means. The target video may include, for example: an uploaded video file, a published video work, live video content, and the like.

In some embodiments, the electronic device 120 may also select a target video 110 from a plurality of videos. As an example, the electronic device 120 may select the target video 110 with a content recommendation intention.

Specifically, the electronic device 120 may determine the target video 110 associated with content recommendation from the plurality of videos with an intention processing model. The intention processing model may include an appropriate machine learning model, examples of which may include, but are not limited to: a deep learning model, a decision tree model, and a graph model, etc.

Further, the intention processing model may acquire a group of video frames of the corresponding video and video description information of the corresponding video, and determine whether the corresponding video is associated with content recommendation.

It should be understood that the intention processing model may be understood as a binary classification model. Specifically, the electronic device 120 may determine a group of video frames from the corresponding video. For example, the electronic device 120 may obtain a predetermined number of video frames from the corresponding video by means of random sampling.

Additionally, the electronic device 120 may also acquire video description information of the corresponding video. The video description information may indicate appropriate text information such as a title and a classification of the video.

Further, based on the model input, the intention processing model may determine whether the video has a content recommendation intention, such as the intention of e-commerce product promotion.

In this way, embodiments of the present disclosure may efficiently filter out the target video with the content recommendation intention, thereby avoiding global processing of a vast amount of videos.

Further, the electronic device 120 may identify one or more objects in the target video 110. Taking the object as a product as an example, for example, the electronic device 120 may identify one or more products appearing in each video frame in the target video 110 with an appropriate object detection model. The object detection model may output, for example, classification information of the product and its location information (e.g., bounding box).

Additionally, the electronic device 120 may determine a plurality of video frames associated with the same object. In some embodiments, for example, the plurality of video frames may include a video frame sequence associated with a target object, and the video frame sequence includes a plurality of video frames which are consecutive. It should be understood that the video frame sequence may be determined with an appropriate object tracking technology.

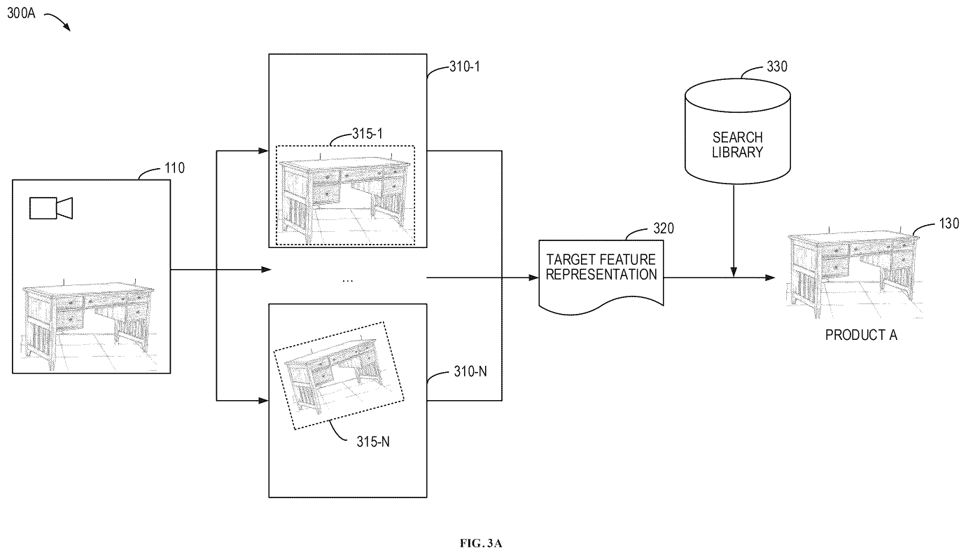

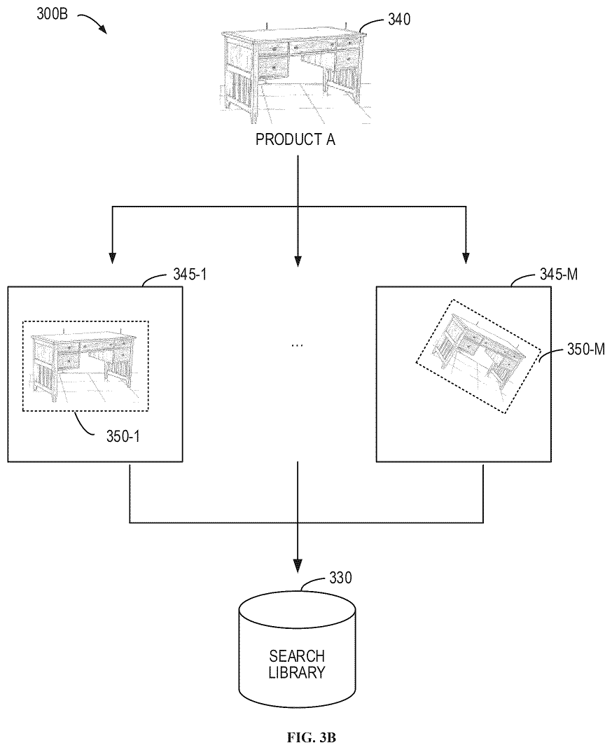

The process at block 210 will be described below with reference to FIG. 3A. FIG. 3A shows a schematic diagram 300A of video content-based processing according to some embodiments of the present disclosure.

As shown in FIG. 3A, the electronic device 120 may determine a plurality of video frames, such as video frame 310-1 to video frame 310-N (individually or collectively referred to as video frame 310), from the target video 110. The video frame 310 may be determined to include, for example, a target object (e.g., a desk). Additionally, the plurality of video frames 310 may be, for example, a sequence of consecutive video frames.

Continuing to refer to FIG. 2, at block 220, the electronic device 120 determines a target feature representation of the target object based on a plurality of visual features of the target object in the plurality of video frames.

Continuing with the example of FIG. 3A, the electronic device 120 may determine visual features of the target object (e.g., a desk) in the plurality of video frames 310. For example, the electronic device 120 may determine a visual feature 315-1 corresponding to the target object from the video frame 310-1, and the electronic device 120 may determine a visual feature 315-N corresponding to the target object from the video frame 310-N.

Additionally, the electronic device 120 may determine a single-frame feature representation corresponding to the visual feature 315-1 to the visual feature 315-N (individually or collectively referred to as visual feature 315). The single-frame feature representation, also referred to as a single-frame feature vector, may be generated accordingly based on the visual feature 315 corresponding to the target object.

Further, the electronic device 120 may determine the target feature representation 320 of the target object based on an aggregation of a plurality of single-frame feature representations.

As an example, the electronic device 120 may determine the target feature representation 320 based on an average or a weighted sum of the plurality of single-frame feature representations. For example, the electronic device 120 may determine the target feature representation 320 based on an average of the plurality of single-frame vectors.

Continuing to refer to FIG. 2, at block 230, the electronic device 120 determines at least one search result associated with the target object based on the target feature representation.

As shown in FIG. 3A, for example, the electronic device 120 may perform match with a search library 330 based on the target feature representation 320. The process of constructing the search library 330 will be described below with reference to FIG. 3B.

In some embodiments, the search library 330 may at least indicate the correspondence between a group of candidate search results and feature representations. Taking the candidate search result as a product as an example, the search library 330 may include, for example, a correspondence or association between each product and at least one feature representation (e.g., a feature vector).

In some embodiments, the electronic device 120 may also determine a target search library for matching with the target feature representation 320 from a plurality of search libraries, for example. Specifically, for example, the electronic device 120 may classify the candidate search results into a plurality of different search libraries according to their categories.

Further, the electronic device 120 may determine, according to category information corresponding to the target feature representation 320.

Further, the electronic device 120 may determine at least one search result corresponding to the target feature representation 320 based on the matching between feature representations. For example, the electronic device 120 may determine, from the search library 330, at least one feature representation that matches with the target feature representation 320 according to a nearest neighbor algorithm (e.g., approximate nearest neighbor (ANN) algorithm), and further may determine at least one search result corresponding to the at least one feature representation.

Considering that a large number of occlusions or motion blurs may occur in a video, embodiments of the present disclosure may aggregate feature representations in a plurality of video frames, which may improve the accuracy of the video feature representation. In addition, the objects appearing in the video may be presented from various angles, which may not necessarily match those shown in the pictures or videos used to construct the search library. By selecting a single picture, recall may be missed, and similarity may be reduced.

In addition, taking a video with an intention of promoting products as an example, it may further determine whether a product is the main product that needs to be displayed in the video by using the sequence. A large number of detection boxes will appear in the video through detection, and not every detection box represents the real intention of promoting products of the video. On the contrary, the product with real promotion intention tend to appear for a long time, are located in the center of the screen, and are displayed from multiple angles. By analyzing the complete sequence, embodiments of the present disclosure may more accurately determine whether an object is truly related to e-commerce intention, thereby reducing the false recall rate.

In some embodiments, the electronic device 120 may also sort at least one recalled search result. Specifically, the electronic device 120 may sort at least one search result; and provide the at least one sorted search result.

In some examples, the electronic device 120 may filter at least one recalled search result, for example, to exclude search results that are clearly not matched with the target video. For example, the electronic device 120 may determine whether to filter the search result based on the matching between the label of the target video and the at least one search result.

For example, the target video may involve clothing recommendation for adult males. Some product pictures may be visually similar to clothing for adult males, but they may belong to children's clothing. Thus, these mismatched search results may be quickly filtered by the label.

Additionally, the electronic device 120 may also sort the recalled search results based on multimodal information. Specifically, the electronic device 120 may sort the at least one search result based at least on first description information of the at least one search result and/or second description information of the target video.

For example, the first description information of the at least one search result may include, for example, a title and a category of the search result. Taking a product as an example, the first description information may include, for example, a name of the product, a category of the product, a grading of the product, and the like. As another example, the second description information of the target video may include, for example, a category of the target video.

In yet another example, the first description information may include, for example, features of all bounding boxes included in the search result, such as visual features of all products appearing in a description picture of the product. The second description information may include, for example, visual features of the video frame sequence as introduced above.

In this way, embodiments of the present disclosure may further improve the accuracy of the search, and significantly reduce the false recall problem.

In some embodiments, the electronic device 120 may accordingly provide the at least one search result. For example, the at least one search result may be presented through a display device of a terminal device.

In some embodiments, the electronic device 120 may provide at least one visual content search result as the at least one search result. The visual content search result includes a picture search result and/or a video search result.

For example, the electronic device 120 may provide, in conjunction with the target video 110, a picture search result and/or a video search result that are/is visually similar to the target object in the target video.

In yet some embodiments, the at least one search result includes at least one product search result, and the electronic device 120 may provide the at least one product search result. Additionally, the electronic device 120 may also provide, in conjunction with the at least one product search result, product visual content associated with the at least one product search result. The product visual content is determined based on the target feature representation.

For example, the electronic device 120 may provide a product (e.g., by a purchase link of the product) that is visually similar to the target object in the target video 110 and provide visual content of the product, e.g., a picture or a video of the product. The picture or video may include, for example, a part that is visually similar to the target object in the target video 110.

The process of constructing the search library 330 is described below with reference to FIG. 3B. Specifically, the electronic device 120 may acquire visual content associated with a group of candidate search results.

As shown in FIG. 3B, the candidate search result may include, for example, a product 340. The candidate search result may include, for example, appropriate products for sale on a platform. Further, the electronic device 120 may acquire related visual content (e.g., visual content 345-1 to 345-M, collectively referred to as visual content 345) of the product 340, e.g., a description picture or a description video of the product.

Further, the electronic device 120 may determine a group of candidate objects indicated by the visual content 345. As an example, the electronic device 120 may identify objects, e.g., products, included in the visual content 345 with an object recognition model.

Additionally, the electronic device 120 may determine a group of visual feature representations of the group of candidate objects. Specifically, the electronic device 120 may determine a bounding box corresponding to each object, and determine its corresponding visual feature, e.g., visual feature 350-1 to visual feature 350-M.

Additionally, the electronic device 120 may construct the search library 330 to indicate the correspondence between the group of candidate search results (e.g., candidate search results 340) and the group of visual feature representations (e.g., visual feature representations 350-1 to 350-M).

Specifically, the electronic device 120 may construct forward indexing information based on positions of bounding boxes, subject information, feature representations, and product label information of the product. Additionally, the electronic device 120 may also take feature representation information of all bounding boxes as inverted indexing information, thereby constructing the search library 330.

In this way, embodiments of the present disclosure may effectively construct the search library, thereby efficiently supporting the determination of the matching search results based on the target feature representation 320, and improving the search efficiency.

### Example Apparatus and Device

Embodiments of the present disclosure further provide a corresponding apparatus for implementing the above method or process.

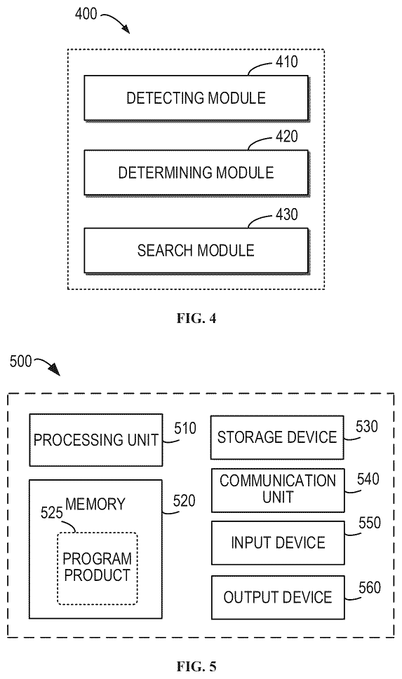

FIG. 4 shows a schematic structural block diagram of an apparatus 400 for video content-based search according to some embodiments of the present disclosure. The apparatus 400 may be implemented as or included in the electronic device 120. The individual modules/components in the apparatus 400 may be implemented by hardware, software, firmware, or any combination thereof.

The apparatus 400 includes a detecting module 410 configured to determine a plurality of video frames associated with a target object in a target video; a determining module 420 configured to determine a target feature representation of the target object based on a plurality of visual features of the target object in the plurality of video frames; and a search module 430 configured to determine at least one search result associated with the target object based on the target feature representation.

In some embodiments, the determining module 420 is further configured to: determine, from the target video, a video frame sequence associated with the target object with an object detection model, where the video frame sequence includes a plurality of video frames which are consecutive.

In some embodiments, the determining module 420 is further configured to: determine a plurality of single-frame feature representations based on the visual feature of the target object in the plurality of video frames; and determine the target feature representation of the target object based on an aggregation of the plurality of single-frame feature representations.

In some embodiments, the search module 430 is further configured to: determine, from a target search library, at least one search result associated with the target object based on the target feature representation, where the target search library at least indicates a correspondence between a group of candidate search results and feature representations.

In some embodiments, the search module 30 is further configured to: determine a category of the target object; and determine, from a plurality of search libraries, the target search library corresponding to the category.

In some embodiments, the apparatus further includes a construction module configured to construct the target search library by: acquiring visual content associated with a group of candidate search results; determining a group of candidate objects indicated by the visual content; determining a group of visual feature representations of the group of candidate objects; and constructing the target search library to indicate a correspondence between the group of candidate search results and the group of visual feature representations.

In some embodiments, the detecting module 410 is further configured to: determine, from a plurality of videos, the target video associated with content recommendation with an intention processing model.

In some embodiments, the intention processing model is configured to: determine whether the corresponding video is associated with content recommendation based on a group of video frames and video description information of the corresponding video.

In some embodiments, the apparatus further includes a first providing module configured to: sort the at least one search result; and provide the at least one sorted search result.

In some embodiments, the providing module is further configured to: sort the at least one search result based at least on first description information of the at least one search result and/or second description information of the target video.

In some embodiments, the apparatus further includes a second providing module configured to: provide at least one visual content search result, where the visual content search result includes a picture search result and/or a video search result.

In some embodiments, the at least one search result includes at least one product search result, and the apparatus further includes a third providing module configured to: provide the at least one product search result; and provide, in conjunction with the at least one product search result, product visual content associated with the at least one product search result, where the product visual content is determined based on the target feature representation.

In some embodiments, the apparatus further includes an acquisition module configured to: acquire at least one of the following as the target video: an uploaded video file, a published video work, or live video content.

FIG. 5 shows a block diagram of an electronic device 500 in which one or more embodiments of the present disclosure may be implemented. It should be understood that the electronic device 500 shown in FIG. 5 is only illustrative and should not constitute any limitation to the function and scope of the embodiments described herein. The electronic device 500 shown in FIG. 5 may be used to implement the electronic device 120 of FIG. 1.

As shown in FIG. 5, the electronic device 500 is in the form of a general-purpose electronic device. The components of the electronic device 500 may include, but are not limited to, one or more processors or processing units 510, a memory 520, a storage device 530, one or more communication units 540, one or more input devices 550, and one or more output devices 560. The processing unit 510 may be a physical or virtual processor and may perform various processes according to programs stored in the memory 520. In a multi-processor system, multiple processing units execute computer-executable instructions in parallel to improve the parallel processing capabilities of the electronic device 500.

The electronic device 500 typically includes multiple computer storage media. Such media may be any available media accessible to the electronic device 500, including but not limited to volatile and non-volatile media, removable and non-removable media. The memory 520 may be volatile memory (e.g., registers, cache, random access memory (RAM)), non-volatile memory (e.g., read-only memory (ROM), electrically erasable programmable read-only memory (EEPROM), flash memory), or some combination thereof. The storage device 530 may be a removable or non-removable medium, and may include a machine-readable medium, such as a flash drive, a magnetic disk, or any other medium, which may be capable of storing information and/or data (e.g., training data for training) and may be accessed within the electronic device 500.

The electronic device 500 may further include additional removable/non-removable, volatile/non-volatile storage media. Although not shown in FIG. 5, a magnetic disk drive for reading from or writing to a removable, non-volatile magnetic disk (e.g., a “floppy disk”) and an optical disk drive for reading from or writing to a removable, non-volatile optical disk may be provided. In these cases, each drive may be connected to a bus (not shown) by one or more data media interfaces. The memory 520 may include a computer program product 525 having one or more program modules configured to perform various methods or actions of various embodiments of the present disclosure.

The communication unit 540 implements communication with other electronic devices through a communication medium. Additionally, the functions of the components of the electronic device 500 may be implemented in a single computing cluster or multiple computing machines that may communicate through a communication connection. Therefore, the electronic device 500 may operate in a networked environment using a logical connection to one or more other servers, network personal computers (PCs), or another network node.

The input device 550 may be one or more input devices, such as a mouse, a keyboard, a trackball, etc. The output device 560 may be one or more output devices, such as a display, a speaker, a printer, etc. The electronic device 500 may also communicate with one or more external devices (not shown) through the communication unit 540 as needed, such as a storage device, a display device, etc., communicate with one or more devices that enable a user to interact with the electronic device 500, or communicate with any device that enables the electronic device 500 to communicate with one or more other electronic devices (e.g., a network card, a modem, etc.). Such communication may be performed via an input/output (I/O) interface (not shown).

According to an example implementation of the present disclosure, a computer-readable storage medium is provided, having a computer-executable instruction stored thereon, where the computer-executable instruction is executed by a processor to implement the above-described method. According to an example implementation of the present disclosure, a computer program product is further provided, the computer program product is tangibly stored on a non-transitory computer-readable medium and includes a computer-executable instruction, and the computer-executable instruction is executed by a processor to implement the above-described method.

Various aspects of the present disclosure are described herein with reference to flowcharts and/or block diagrams of methods, apparatuses, devices, and computer program products implemented according to the present disclosure. It should be understood that each block of the flowcharts and/or block diagrams and combinations of blocks in the flowcharts and/or block diagrams may be implemented by computer-readable program instructions.

These computer-readable program instructions may be provided to a processing unit of a general-purpose computer, a special-purpose computer or other programmable data processing apparatus, to produce a machine, such that the instructions, when executed by the processing unit of the computer or other programmable data processing apparatus, generate an apparatus for implementing the functions/acts specified in one or more blocks of the flowcharts and/or block diagrams. These computer-readable program instructions may also be stored in a computer-readable storage medium, and these instructions cause the computer, the programmable data processing apparatus and/or other devices to work in a specific manner, so that the computer-readable medium storing the instructions includes a manufactured product, which includes instructions for implementing various aspects of the functions/acts specified in one or more blocks of the flowcharts and/or block diagrams.

These computer-readable program instructions may be loaded onto a computer, other programmable data processing apparatus, or other device, such that a series of operational steps are performed on the computer, other programmable data processing apparatus, or other device to produce a computer-implemented process, such that the instructions executed on the computer, other programmable data processing apparatus, or other device implement the functions/acts specified in one or more blocks of the flowcharts and/or block diagrams.

The flowcharts and block diagrams in the drawings show possible architectures, functions, and operations of the system, method, and computer program product implemented according to multiple implementations of the present disclosure. In this regard, each block in the flowcharts or block diagrams may represent a module, a program segment, or a portion of instructions, the module, the program segment, or the portion of instructions containing one or more executable instructions for implementing specified logical functions. In some alternative implementations, the functions noted in the blocks may also occur out of the order noted in the figures. For example, two blocks shown in succession may, in fact, be executed substantially concurrently, or the blocks may sometimes be executed in a reverse order, depending upon the functionality involved. It should also be noted that each block of the block diagrams and/or flowcharts, and combinations of blocks in the block diagrams and/or flowcharts, may be implemented by a dedicated hardware-based system that performs the specified functions or acts, or may be implemented by a combination of dedicated hardware and computer instructions.

Various implementations of the present disclosure have been described above, and the above description is illustrative, not exhaustive, and is not limited to the disclosed implementations. Many modifications and variations will be apparent to those skilled in the art without departing from the scope and spirit of the described implementations. The terms used herein are chosen to best explain the principles of the implementations, the practical application or the improvement of the technology in the market, or to enable other ordinary skilled in the art to understand the implementations disclosed herein.

1. A method for video content-based processing, comprising:
determining, in a target video, a plurality of video frames associated with a target object;
determining a target feature representation of the target object based on a plurality of visual features of the target object in the plurality of video frames; and
determining at least one search result associated with the target object based on the target feature representation.

2. The method according to claim 1, wherein determining, in the target video, the plurality of video frames associated with the target object comprises:
determining, by an object detection model, a video frame sequence associated with the target object from the target video, the video frame sequence comprising the plurality of video frames which are consecutive.

3. The method according to claim 1, wherein determining the target feature representation of the target object based on the plurality of visual features of the target object in the plurality of video frames comprises:
determining a plurality of single-frame feature representations based on the visual features of the target object in the plurality of video frames; and
determining the target feature representation of the target object based on an aggregation of the plurality of single-frame feature representations.

4. The method according to claim 1, wherein determining the at least one search result associated with the target object based on the target feature representation comprises:
determining, from a target search library, the at least one search result associated with the target object based on the target feature representation, the target search library at least indicating a correspondence between a group of candidate search results and feature representations.

5. The method according to claim 4, further comprising:
determining a category of the target object; and
determining, from a plurality of search libraries, the target search library corresponding to the category.

6. The method according to claim 4, further comprising:
constructing the target search library by:
acquiring visual content associated with the group of candidate search results;
determining a group of candidate objects indicated by the visual content;
determining a group of visual feature representations of the group of candidate objects; and
constructing the target search library to indicate the correspondence between the group of candidate search results and the group of visual feature representations.

7. The method according to claim 1, further comprising:
determining, by an intention processing model, the target video associated with content recommendation from a plurality of videos.

8. The method according to claim 7, wherein the intention processing model is configured to:
determine whether a video is associated with content recommendation based on a group of video frames and video description information of the video.

9. The method according to claim 1, further comprising:
sorting the at least one search result; and
providing the at least one sorted search result.

10. The method according to claim 9, wherein sorting the at least one search result comprises:
sorting the at least one search result based at least on first description information of the at least one search result and/or second description information of the target video.

11. The method according to claim 1, wherein the at least one search result comprises at least one visual content search result, and the method further comprises:
providing the at least one visual content search result, wherein the visual content search result comprises a picture search result and/or a video search result.

12. The method according to claim 1, wherein the at least one search result comprises at least one product search result, and the method further comprises:
providing the at least one product search result; and
providing, in conjunction with the at least one product search result, product visual content associated with the at least one product search result, the product visual content being determined based on the target feature representation.

13. The method according to claim 1, further comprising acquiring at least one of the following as the target video:
an uploaded video file,
a published video work, or
live video content.

14. (canceled)

15. An electronic device, comprising:
at least one processor; and
at least one memory coupled to the at least one processor and storing instructions executable by the at least one processor, the instructions, when executed by the at least one processor, causing the device to perform operations comprising:
determining, in a target video, a plurality of video frames associated with a target object;
determining a target feature representation of the target object based on a plurality of visual features of the target object in the plurality of video frames; and
determining at least one search result associated with the target object based on the target feature representation.

16. A non-transitory computer-readable storage medium having a computer program stored thereon, the computer program being executable by a processor to perform operations comprising:
determining, in a target video, a plurality of video frames associated with a target object;
determining a target feature representation of the target object based on a plurality of visual features of the target object in the plurality of video frames; and
determining at least one search result associated with the target object based on the target feature representation.

17. (canceled)

18. The electronic device according to claim 15, wherein determining, in the target video, the plurality of video frames associated with the target object comprises:
determining, by an object detection model, a video frame sequence associated with the target object from the target video, the video frame sequence comprising the plurality of video frames which are consecutive.

19. The electronic device according to claim 15, wherein determining the target feature representation of the target object based on the plurality of visual features of the target object in the plurality of video frames comprises:
determining a plurality of single-frame feature representations based on the visual features of the target object in the plurality of video frames; and
determining the target feature representation of the target object based on an aggregation of the plurality of single-frame feature representations.

20. The electronic device according to claim 15, wherein determining the at least one search result associated with the target object based on the target feature representation comprises:
determining, from a target search library, the at least one search result associated with the target object based on the target feature representation, the target search library at least indicating a correspondence between a group of candidate search results and feature representations.

21. The electronic device according to claim 20, wherein the instructions, when executed by the at least one processor, causing the device to perform operations further comprising:
determining a category of the target object; and
determining, from a plurality of search libraries, the target search library corresponding to the category.

22. The electronic device according to claim 20, wherein the instructions, when executed by the at least one processor, causing the device to perform operations further comprising:
constructing the target search library by:
acquiring visual content associated with the group of candidate search results;
determining a group of candidate objects indicated by the visual content;
determining a group of visual feature representations of the group of candidate objects; and
constructing the target search library to indicate the correspondence between the group of candidate search results and the group of visual feature representations.
